(19) United States
(12) Patent Application Publication
(10) Pub. No.: US 2013/0017349 A1
(43) Pub. Date: Jan. 17, 2013

(54) COATED SUBSTRATE, A PROCESS FOR PRODUCTION OF A COATED SUBSTRATE, A PACKAGE AND A DISPERSION COATING

(71) Applicants: Isto Heiskanen, Imatra (FI); Kaj Backfolk, Lappeenranta (FI); Lars Axrup, Hammaro (SE)

(72) Inventors: Isto Heiskanen, Imatra (FI); Kaj Backfolk, Lappeenranta (FI); Lars Axrup, Hammaro (SE)

(73) Assignee: STORA ENSO OYJ, Helsinki (FI)

(21) Appl. No.: 13/505,701

(22) PCT Filed: Nov. 2, 2010
(86) PCT No.: PCT/SE2010/051190

§ 371 Date: May 16, 2012

(30) Foreign Application Priority Data
Nov. 3, 2009 (SE) 0950819-3

(51) Int. Cl. C09D 101/00; B32B 1/02; C09D 127/08; C09D 129/04; C09D 129/06; C09D 133/08; C09D 125/04; C09D 109/00; C09D 123/00; C09D 133/20; C09D 167/06; C09D 133/10; C09D 131/04; C09D 101/10; C09D 103/08; B05D 3/02; B05D 1/02; B05D 1/28; B05D 1/26; B32B 33/00

(52) U.S. Cl. 428/36.1; 428/221; 524/35; 106/162.9; 106/162.5; 427/372.2

(57) ABSTRACT

The present invention relates to a coated fiber based substrate comprising a dispersion coating wherein said dispersion coating comprises microfibrillated cellulose and colloidal particles of a polymer. The invention further relates to a package formed from said substrate, a dispersion coating and process for the production of mentioned substrate.

### FIELD OF THE INVENTION

The present invention relates to a coated substrate and a process for the production of a coated fiber based substrate wherein the coating comprises microfibrillated cellulose.

### BACKGROUND

Fiber based products used as packages, such as liquid packages or food packages, must be able to withstand the influence of the packed items such as the influence of liquids and/or food on the fiber based product. One way is to provide the fiber based product with a barrier, for example a water or grease resistant barrier which makes the fiber based product more resistant against liquids and/or grease.

Barriers are normally created by coating the fiber based substrate with a composition which gives the substrate barrier properties. Different coatings can be applied depending on the needed properties of the barrier. The most commonly used materials when forming a barrier on a fiber based product, are polyethylene (PE), polypropylene (PP), polyethylene therephthalate (PET), ethylene vinyl alcohol (EVOH) or ethylene vinyl acetate (EVA). The polymers can for example be laminated or extrusion coated to the fiber based product. Currently, most of the barrier coatings are manufactured with extrusion coating techniques and hence made off-line in a separate coating unit. This increases the flexibility of the paper or board machine since different operation schedules can be used on the paper or board machine and the extrusion coating unit. However, the main disadvantage is that is expensive since it requires extra handling of the reels and an extra converting step.

It is thus preferred to produce a paper or board comprising a barrier in an on-line process which means that the barrier coating takes place on-line in the paper or board machine. This process step should preferably be done with a barrier dispersion coating unit, which will utilize conventional coating techniques. US 2002136913, describes a fiber based product which comprises a water vapor barrier produced by dispersion coating aqueous polymers to the fiber based product.

Another important property for a fiber based product comprising a barrier is that its strength and above all its bending resistance is good enough in order for a package to be formed. It is important that the package is strong enough to secure protection of the packed items both during transportation, storage and converting. If the bending resistance is too low, the fiber based product will be brittle and there will be problems during converting, especially during creasing of the product to form a package. It is also of most important that the barrier also is able to withstand the demands of the coated fiber substrate during handling, transportation and converting.

Dispersion coatings can, as previously stated, be used for the production of barriers on a fiber based product. However, it has been shown that dispersion coatings will decrease the bending resistance of the coated fiber based product and there will thus be problems during creasing of the product to form a package.

There is thus a need for an improved fiber based product which comprises a barrier.

### SUMMARY OF THE INVENTION

It is an object of the present invention to provide an improved fiber based substrate comprising a dispersion coating.

Another object of the present invention is to provide a recyclable fiber based substrate comprising a dispersion coating.

These objects and other advantages are achieved by the substrate according to claim 1. The present invention relates to a coated fiber based substrate comprising a dispersion coating wherein said dispersion coating comprises microfibrillated cellulose and colloidal particles of a polymer wherein said dispersion coating forms a barrier on the surface of the substrate. It has been shown that the addition of microfibrillated cellulose (MFC) to a dispersion coating increases the strength and above all decreases the brittleness of the dispersion coating and thus also of the coated fiber based substrate. Furthermore, MFC is a recyclable material which facilitates the recycling of the coated substrate.

It is preferred that the barrier is a barrier against liquids, vapor, grease, detergents, oxygen or other gases. Different polymers will give the coated substrate different barrier properties, i.e. the choice of polymer control the properties of the barrier.

The dispersion coating preferable comprises 0.5-20% by weight of microfibrillated cellulose. The amount of MFC in the dispersion coating depends on the end use of the coated substrate.

The microfibrillated fibers may have a wide distribution range of the length, preferable between 100 nm-200 μm, i.e. the length of the added MFC may thus longer than normally produced MFC. It has been shown that by increasing the length of the produced MFC the bending resistance of the barrier layer is increased.

The dispersion coating comprises at least one polymer, preferable polyvinylidene chloride (PVdC), poly vinyl alcohol (PVOH), ethylene vinyl alcohol (EVOH), acrylate copolymers, modified styrene, butadiene, polyolefins, acrylonitrile, fumaric or maleic diesters, cellusose esters, starch ethers, different acrylates and methacrylates, vinyl acetates or a mixture of any of these polymers. It is preferred to use polymers which make it possible to reuse and recycle the coated fiber based substrate in an easy way. This is a big advantage with the use of dispersion coating compared with for example extrusion coating.

The present invention also relates to a package which is produced by the coated substrate as previously described. The coated substrate is thus creased and folded in order for a package to form. The coated side of the substrate is preferable located inside of the package. It has been found the coated fiber based substrate according to the invention has improved resistance against, for example grease when a polymer which gives the barriers grease resistance properties are used, when the substrate is creased and folded. Thus, the formed package will have improved properties and be much more resistance, especially in the creases.

The dispersion coating according to the invention comprises microfibrillated cellulose and colloidal particles of a polymer and said dispersion coating forms a barrier on a coated substrate. It has been shown that the addition of MFC to a dispersion coating increases the stability of the dispersion.

The present invention also relates to a process for producing a coated substrate which process comprises the steps of, providing a substrate comprising cellulosic fibers, applying a dispersion coating to the surface of the substrate wherein the dispersion coating comprises micro fibrillated cellulose and colloidal particles of a polymer and drying of the substrate to form a dried coated substrate.

The dispersion coating is preferable applied by the use of roller coating, spray coating, slot coating, immersion coating, gravure roll coating, reverse direct gravure coating and/or combinations thereof.

The dispersion coating is preferable applied on-line in a paper or board machine. A big advantage with the process according to the invention is that it is possible to add the dispersion coating comprising MFC on-line in the paper or board machine.

### DETAILED DESCRIPTION

The invention relates to a coated fiber based substrate comprising a dispersion coating on at least one side of the substrate. The dispersion coating comprises micro fibrillated cellulose. It has been shown that addition of microfibrillated cellulose to a dispersion coating improves both the water holding capacity as well as the creasing properties, i.e. reduces the brittleness, of the coating and thus also of the coated fiber substrate. The addition of MFC to the dispersion coating also improves the stability of the dispersion.

Microfibrillated cellulose (MFC) (also known as nanocellulose) is a material made from wood cellulose fibers, where the individual microfibrils have been partly or totally detached from each other. MFC is normally very thin (˜20 nm) and the length is often between 100 nm to 10 μm. However, the microfibrils may also be longer, for example between 10-100 μm but lengths up to 200 μm can also be used. Fibers that has been fibrillated and which have microfibrils on the surface and microfibrils that are separated and located in a water phase of a slurry are included in the definition MFC.

MFC can be produced in a number of different ways. It is possible to mechanically treat cellulosic fibers so that microfibrils are formed. The production of nanocellulose or microfibrillated cellulose with bacteria is another option. It is also possible to produce microfibrils from cellulose by the aid of different chemicals and/or enzymes which will break or dissolve the fibers.

One example of production of MFC is shown in WO2007091942 which describes production of MFC by the aid of refining in combination with addition of an enzyme.

Monomers or co-binders are often added to a dispersion coating in order to increase the water holding capacity of the dispersion. Microfibrillated cellulose has a very high water holding capacity and it is thus possible to decrease the amount of monomers or co-binders added to the dispersion coating. Moreover, the addition of MFC to a dispersion coating makes it possible to control the viscosity of the dispersion and this makes it possible to improve the runnability of the coating equipment in a very easy way. Furthermore, both the water holding ability and the hold out of the coating layer can be improved by the improved possibility to control and adjust the viscosity of the dispersion. Another advantages with the increased possibility to control and adjust the viscosity are that immobilization and coating color penetration in the coating nip is improved as well as it enables better coverage and less pinholes when applying the dispersion coating to the surface of the substrate.

Moreover, microfibrillated cellulose creates an extended network in the dispersion and this strongly improves the flexibility of the dried coating layer as well as reduces cracking of the coating layer in converting processes. Furthermore, the added MFC changes the bonding properties between the base board and the barrier layer and this also effects and contributes to improved cracking resistance. Thus, it has been shown that by addition of MFC to a dispersion which preferable comprises a polymer increases the flexibility and thus also the strength during creasing and folding of the coated fiber based substrate.

It has been shown that addition of microfibrillated fibers which are quite long, for example with a length of 5-200 μm or more preferable between 5-50 μm further increases the bending resistance of the formed barrier.

It is also possible to modify the microfibrillated cellulose before addition to the dispersion coating. In this way it is possible to obtain an even stronger stabilizing effect of the dispersion. How the modification of the microfibrillated fibers is done depends, for example on the other components present in the dispersion coating. One possibility is to add chemicals which will alter the charge of the fibers and in this way increase the stability of the dispersion.

The dispersion coating works as a barrier and it may thus give the substrate improved resistance against for example, liquids, vapor, grease, oxygen or other gases. The most commonly used barriers for liquid packaging boards are water resistance barriers. Products used for food packages often comprise a barrier against water vapor, grease and/or oxygen.

The dispersion coating may be added to the surface of the substrate by the aid of several different techniques, preferred coating techniques are blade, film press or curtain coating. However, other coating techniques could also be used, such as roller coating, spray coating, slot coating, immersion coating, gravure roll coating, reverse direct gravure coating and/or combinations thereof. It may also be possible to use rod, size press, air blade, metered size press, flexo coating, anilox applicator rolls or combination of any the mentioned techniques.

Dispersion coating which is used to create a barrier, i.e. a barrier coating, relates to a coating technique in which an aqueos dispersion comprising fine polymer particles, such as latex, is applied to the surface of a fiber substrate to form a solid, non porous film after drying. In this way it is possible to to achieve a barrier layer against liquids, vapor, grease, oxygen or other gases by an environmental friendly (recyclable) and repulpable coating.

Dispersion coatings may be based on various polymer dispersions. The dispersion comprises dispersed colloidal particles of polymers and a solvent, which preferable is water. Examples of polymers and/or additives commonly used are polyvinylidene chloride (PVdC), poly(vinyl)alcohol (PVOH), ethylene vinyl alcohol (EVOH), acrylate copolymers, modified styrene, butadiene, polyolefins, acrylonitrile, fumaric and maleic diesters, cellusose esters, starch ethers, different acrylates and methacrylates, vinyl acetates, copolymers of these or other natural biopolymers and mixtures of the mentioned polymers. Several constituents may also be added in order to improve barrier and other properties, such as surface tension, wetting, slip, rub resistance, film formation etc of the coated substrate.

As used herein, “polymer” may be used to refer to homopolymers, copolymers, interpolymers, terpolymers, etc.

The dispersion may also contain various amounts of fillers to increase for example runnability and cost-efficiency of the process and the produced substrate. Furthermore, vexes, such as paraffin, carnauba wax and/or akd may be used in order to hydrofobize the surface of the coated substrate.

The solid content of the dispersion coating may be between 25-70% by weight. The viscosity of the dispersion used for dispersion coating is preferable between 500-1000 mPas. However, the dispersion may be diluted with water or any other solvent in order to achieve the desired viscosity.

The substrate may be coated with a conventional coating before addition of the dispersion coating to the surface of the substrate. In this way, the dispersion coating will bond stronger to the substrate since the surface of the substrate is smoother. Also, the penetration of water and/or dispersion coating into the surface of the substrate will be decreased.

It is also possible to apply more than one layer of dispersion coatings to the surface of the substrate. In this way a smoother coating layer is formed since the amount of coating in each layer can be reduced. It is easier to apply a thin layer of coating compared to if high amounts of coating should be applied in one layer.

It is important to be able to reuse and recycle the fibers in a paper or board product. The recycling of a fiber based product which has been dispersion coated is facilitated, both in the paper making process and after recycled in the end of the life cycle. It is much easier to recycle a dispersion coating which is added to a paper or board compared to a laminated or extrusion coated barrier. It is also preferred that the dispersion coating comprises products which comes from renewable sources, such as from potato, corn, cereals, wood, xylane or similar products. Micro fibrillated cellulose is a renewable source and the addition of microfibrillated cellulose will also improve and facilitate the recycling of the dispersion coated product according to the invention.

The addition of the dispersion coating is preferable done on-line in the paper or board machine. However, it can also be done off-line.

The coated substrate may be coated on one or both sides. The coated substrate is dried after the addition of the dispersion coating and any conventional drying technique can be used.

The substrate is preferable a paper or board product. However, other products such as textiles, plastics etc can also be used.

### Example

An uncoated paperboard was used as a baseboard. The baseboard has a basis weight of 210 gsm and a Bendtsen roughness level of 400-500 ml/min.

The baseboard was dispersion coated with a commercially available dispersion coating called Cartaseal TXU which is a latex based dispersion in water that are produced by Clariant (UK). The dispersion was both used as such, as a reference hereinafter called “Ref. sample”, and by mixing microfibrillated cellulose with the dispersion, hereinafter called “Sample MFC”. MFC was dosed to the dispersion used for the sample MFC until Brookfield viscosity was about 1000 mPas.

The uncoated paperboard was dispersion coated with the aid of a rod coating unit on sheets. The dispersion coating on both samples has a weight of 15 gsm.

The sheets were thereafter dried.

The microfibrillated cellulose was produced at high consistency from bleached pine sulfite pulp. The bleached pulp was first pre-mechanically treated in refiner at a consistency of 25% followed by enzymatic treatment by cellulase with the activity of 250ECU and the pulp was finally mechanically treated in a refiner at a consistency of 25%.

Water Vapor Transmission Resistance was measured for the barrier coatings according to the procedure as described in the ASTM F-1249 standard. A Permatran-W 3/31 (Mocon) instrument was used. A sample area of the board of 5 cm² was used. The N_{2(H2O)} flow 200 ml/min, N_{2(carrier)} flow 100 ml/min and RH was 50-51%.

Grease permeability was determined according to the modified ASTM F119-82 method. The test samples were both tested flat as well as creased and folded by a 2.07 kg roller. The samples were thereafter exposed on the barrier side to chicken fat at 40° C. and 0% RH. The time required to show a visual change on the opposite surface of the board, i.e. show through time, and on the TLC plate with a 254 nm fluorescent indicator placed under the board, i.e. break through time, were noted. The samples were checked every 15 minutes for the first hour and once every hour for the next 7 hours. In the second day grease permeation were checked once.

Results:

TABLE 1
WVTR measured on the samples.

| | WVTR at 25° C. and 50% RH |
|---|---|
| Ref Sample | 250 |
| Sample MFC | 190 |

As can be seen from Table 1 the WVTR decreases by the addition of MFC, i.e. the paperboard is more resistant to water vapor.

TABLE 2
Grease resistance

| | | Show-through time | | Break-through time | |
|---|---|---|---|---|---|
| Ref Sample | Flat | 32-48 | hours | 32-48 | hours |
| | Creased and | <15 | min | <15 | min |
| | Folded | | | | |
| Sample MFC | Flat | 32-48 | hours | 32-48 | hours |
| | Creased and | 8-24 | hours | 32-48 | hours |
| | Folded | | | | |

It can be seen from Table 2 that the sample comprising MFC in the barrier coating achieved good grease and fat resistance compared to the reference sample. It was surprisingly found that the grease resistance for the creased and folded sample improved so much when MFC was added to the dispersion coating. The results also show that the dispersions coating previously used not are sufficiently resistant to grease when the sample is creased and folded.

1. A coated fiber based substrate comprising a dispersion coating wherein said dispersion coating comprises microfibrillated cellulose and colloidal particles of a polymer, which dispersion coating forms a barrier on the surface of the substrate.

2. The substrate according to claim 1 wherein the dispersion coating comprises 0.5% to 20% by weight of microfibrillated cellulose.

3. The substrate according to claim 1 wherein the microfibrillated fibers has a length of 100 nm-200 μm.

4. The substrate according to claim 1 wherein the polymer is polyvinylidene chloride (PVdC), poly vinyl alcohol (PVOH), ethylene vinyl alcohol (EVOH), acrylate copolymers, modified styrene, butadiene, polyolefins, acrylonitrile, fumaric or maleic diesters, cellusose esters, starch ethers, different acrylates and methacrylates, vinyl acetates, polymers which origins from potato, corn, cereals, wood, xylane or similar products or a mixture of any of these polymers.

5. The substrate according to claim 1 wherein the barrier is a barrier against liquids, vapor, grease, detergents, oxygen or other gases.

6. A package produced by the coated substrate according to claim 1 wherein the substrate is bended or folded in order to form a package.

7. A dispersion coating comprising microfibrillated cellulose and colloidal particles of a polymer and that the dispersion coating forms a barrier on a coated substrate.

8. The dispersion coating according to claim 7 wherein the polymer is polyvinylidene chloride (PVdC), poly vinyl alcohol (PVOH), ethylene vinyl alcohol (EVOH), acrylate copolymers, modified styrene, butadiene, polyolefins, acrylonitrile, fumaric and maleic diesters, cellusose esters, starch ethers, different acrylates or methacrylates, vinyl acetates, polymers which origins from potato, corn, cereals, wood, xylane or similar products or a mixture of any of these polymers.

9. The dispersion coating according to claim 7 wherein the dispersion coating comprises 0.5-20% by weight of microfibrillated cellulose.

10. A process for producing a coated substrate which process comprises the steps of:
providing a substrate comprising cellulosic fibers,
applying a dispersion coating to the surface of the substrate wherein the dispersion coating comprises micro fibrillated cellulose and colloidal particles of a polymer,
drying of the substrate to form a dried coated substrate.

11. The process according to claim 10 wherein the dispersion coating is applied by the use of roller coating, spray coating, slot coating, immersion coating, gravure roll coating, reverse direct gravure coating and/or combinations thereof.

12. The process according to claim 10 wherein the dispersion coating is applied on-line in a paper or board machine.
